(19) United States
(12) Patent Application Publication
(10) Pub. No.: US 2026/0146892 A1
(43) Pub. Date: May 28, 2026

(54) MAGNETO-OPTICAL CHEMICAL SENSORS FOR PROCESS CHAMBERS

(71) Applicant: Applied Materials, Inc., Santa Clara, CA (US)

(72) Inventor: TIMOTHY CHEN, Los Altos, CA (US)

(21) Appl. No.: 18/957,428

(22) Filed: Nov. 22, 2024

(51) Int. Cl. G01J 4/04; G01J 3/447; G01N 21/17

(52) U.S. Cl. CPC G01J 4/04; G01J 3/447; G01N 21/1717; G01N 2021/1727

(57) ABSTRACT

Magneto-optical sensors for process or process chamber condition monitoring are described. In an example, a system includes a process chamber. The system also includes a laser source to provide a laser beam having an initial polarization, the laser beam to be directed through a first polarizer and then into the process chamber. The system also includes a magnet surrounding the process chamber, the magnet to provide a Faraday rotation of the laser beam, the laser beam to exit the process chamber and enter a second polarizer and then a detector to provide a detected polarization rotation for lock-in detection.

### BACKGROUND

### 1) Field

Embodiments of the present disclosure pertain to the field of process monitoring such as to magneto-optical sensors for radical detection in-chamber for process chambers.

### 2) Description of Related Art

The fabrication of microelectronic devices, display devices, micro-electromechanical systems (MEMS), and the like require the use of one or more processing chambers. For example, processing chambers such as, but not limited to, an atomic layer deposition (ALD) chamber, a plasma enhanced chemical vapor deposition chamber, a physical vapor deposition chamber, or a plasma treatment chamber may be used to fabricate various devices. As scaling continues to drive to smaller critical dimensions in such devices, the need for uniform processing conditions (e.g., uniformity across a single substrate, uniformity between different lots of substrates, and uniformity between chambers in a facility) as well as process stability during the process are becoming more critical in high volume manufacturing (HVM) environments.

Processing non-uniformity and non-stability arise from many different sources. Sensors may be used to reduce the impact of such non-uniformity and non-stability.

### SUMMARY

Embodiments of the present disclosure include magneto-optical sensors for process chambers.

In an embodiment, a system including a magneto-optical sensor for a process includes a process chamber. The system also includes a laser source to provide a laser beam having an initial polarization, the laser beam to be directed through a first polarizer and then into the process chamber. The system also includes aa surrounding the process chamber, the magnet to provide a Faraday rotation of the laser beam, the laser beam to exit the process chamber and enter a second polarizer and then a detector to provide a detected polarization rotation for lock-in detection. A remote plasma source can be coupled to the process chamber, in another embodiment.

In another embodiment, a system including a magneto-optical sensor for a process includes a process chamber. The system also includes a laser source to provide a laser beam having an initial polarization, the laser beam to be directed through a first polarizer and then into the process chamber. The system also includes a magnet surrounding the process chamber, the magnet to provide a Faraday rotation of the laser beam, the laser beam to exit the process chamber and enter a second polarizer and then a detector to provide a detected polarization rotation to a lock-in amplifier.

In another embodiment, a system including a process chamber. The system also includes a laser source to provide a laser beam having an initial polarization, the laser beam to be directed through a first polarizer and then into the process chamber. The system also includes a Helmholtz coil surrounding the process chamber, the Helmholtz coil to provide a Faraday rotation of the laser beam, the laser beam to exit the pre-process chamber and enter a second polarizer and then a detector to provide a detected polarization rotation to a lock-in amplifier.

### BRIEF DESCRIPTION OF THE DRAWINGS

FIG. 1 is a schematic of a system including a magneto-optical sensor for a process chamber, in accordance with an embodiment of the present disclosure.

FIG. 2A illustrates (a) a plot of direct laser absorption, and (b) a plot of Faraday rotation spectroscopy, in accordance with an embodiment of the present disclosure.

FIG. 2B illustrates (a) a plot of demodulated Filtered Rayleigh Scattering (FRS) signal (mV) as a function of time (seconds) for magnet modulation with laser scan with plasma off, (B) a plot of demodulated Filtered Rayleigh Scattering (FRS) signal (mV) as a function of time (seconds) for dual modulation (magnet and laser) with plasma off, and (c) a plot of demodulated Filtered Rayleigh Scattering (FRS) signal (mV) as a function of time (seconds) for triple modulation (magnet and laser) with plasma on, in accordance with an embodiment of the present disclosure.

FIG. 3 is a schematic of another system including a magneto-optical sensor for a process chamber, in accordance with an embodiment of the present disclosure.

FIG. 4 is a schematic of another system including a magneto-optical sensor for a process chamber, in accordance with an embodiment of the present disclosure.

FIG. 5 is a schematic of another system including a magneto-optical sensor for a process chamber, in accordance with an embodiment of the present disclosure.

FIG. 6 is a schematic of another system including a magneto-optical sensor for a process chamber, in accordance with an embodiment of the present disclosure.

FIG. 7 is a schematic of another system including a magneto-optical sensor for a process chamber, in accordance with an embodiment of the present disclosure.

FIG. 8 is a schematic of another system including a magneto-optical sensor for a process chamber, in accordance with an embodiment of the present disclosure.

FIG. 9A is a schematic of another system including a magneto-optical sensor for a process chamber, in accordance with an embodiment of the present disclosure.

FIG. 9B is a schematic of another system including a magneto-optical sensor for a process chamber, in accordance with an embodiment of the present disclosure.

FIG. 10 illustrates a cross-section view of a process chamber including one or more magneto-optical sensors, in accordance with an embodiment of the present disclosure.

FIG. 11 provides a schematic of a deposition apparatus that includes the integration of magneto-optical sensor modules in various locations, in accordance with an embodiment of the present disclosure.

FIG. 12A is a schematic, cross-sectional view of a plasma processing apparatus that includes one or more magneto-optical sensor modules, in accordance with an embodiment of the present disclosure.

FIG. 12B is a schematic depiction of a layout of the access tubes within spokes of a chamber body assembly of the plasma processing apparatus of FIG. 12A, in accordance with an embodiment of the present disclosure.

FIG. 13 is a cross-sectional illustration of a deposition apparatus that can include one or more magneto-optical sensor modules, in accordance with an embodiment of the present disclosure.

FIG. 14 illustrates a block diagram of an exemplary computer system of a processing tool, in accordance with an embodiment of the present disclosure.

### DETAILED DESCRIPTION

Magneto-optical sensors for processing (e.g., a deposition) chambers are described. In the following description, numerous specific details are set forth, such as chamber configurations and magneto-optical sensor architectures, in order to provide a thorough understanding of embodiments of the present disclosure. It will be apparent to one skilled in the art that embodiments of the present disclosure may be practiced without these specific details. In other instances, well-known aspects, such as quantitative measurements, are not described in detail in order to not unnecessarily obscure embodiments of the present disclosure. Furthermore, it is to be understood that the various embodiments shown in the Figures are illustrative representations and are not necessarily drawn to scale.

One or more embodiments are directed to magneto-optical sensors for radical detection in-chamber. One or more embodiments are directed to magneto-optical spectroscopic sensors for enhanced in situ radical concentration detection in processing chambers. One or more embodiments are directed to methods to detect trace concentrations of radicals in processing chambers using Faraday and Voigt rotation spectroscopy of laser light. Embodiments can include Faraday rotation spectroscopy, laser diagnostics, radical detection, and/or in situ detection.

To provide context, in situ detection of radicals in processing chambers is challenging due to their relatively low concentration. In accordance with embodiments described herein, magneto-optical (Faraday or Voigt) rotation spectroscopy is used to perform radical selective detection with enhanced sensitivity compared to absorption spectroscopy. Embodiments can be implemented to enable real-time in situ monitoring of radical species in processing chambers as well as at the output of remote plasma sources.

To provide further context, detection of radicals with absorption spectroscopy is often hindered by the interferences from stable molecules. For example, OH and H₂O molecules absorb at similar Infra-Red (IR) frequencies for OH bond stretching. Approaches described herein are selective to radicals due to the application of a magnetic field. In one embodiment, only radical species may respond to this magnetic field and generate a signal. In one embodiment, a sampling probe is not needed as in in quadrupole mass spectroscopy. In one embodiment, the sensitivity can be enhanced by two-tone modulation of the laser.

In accordance with an embodiment of the present disclosure, more than an order of magnitude enhancement in the OH detection sensitivity can be obtained as compared to direct laser absorption spectroscopy. Furthermore, embodiments can be implemented using cost-effective near-IR laser sources to perform techniques described herein for OH detection (e.g., 1434 nm). Such laser sources can be up to three to four times less expensive than mid-IR lasers (e.g., 2800 nm). Interferences by nearby H₂O signals have been eliminated. This approach can be used for atomic radicals such as O at 630 nm.

In an embodiment, laser light first passes through a polarizer to ensure a clean polarization state. The laser then enters the chamber through a window and propagates through the chamber. In one region, a magnetic field is applied using either permanent magnets or an electromagnet such as an air-core solenoid or Helmholtz coil. The magnetic field can propagate through standard vacuum fittings made of stainless steel. The magnetic field in an inductively coupled plasma (ICP) chamber can also be used. The laser polarization axis experiences Faraday or Voigt rotation once exposed to radicals and the magnetic field. The polarization rotation can be detected using a polarimeter. Potential polarimeter options are described below. In an embodiment, a laser and magnetic field can be modulated to provide background-free signals. The laser can then be modulated with a 1f and 3f waveform in addition to an AC magnetic field for triple modulation Faraday rotation spectroscopy. A lock-in amplifier can be implemented to demodulate the signal for real-time analysis.

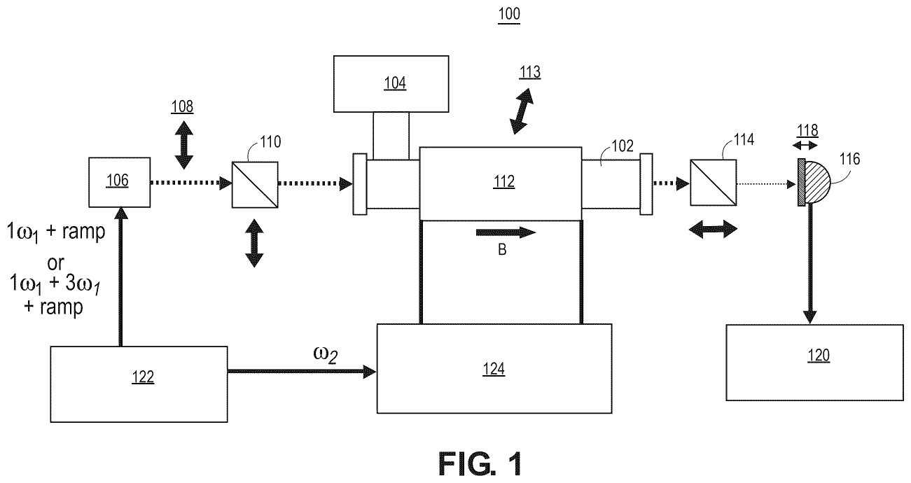

As a first exemplary arrangement, FIG. 1 is a schematic of a system including a magneto-optical sensor for a process chamber, in accordance with an embodiment of the present disclosure.

Referring to FIG. 1, a system 100 includes a process chamber 102 coupled to a remote plasma source 104. A laser 106 provides a laser beam having an initial polarization 108. The laser beam is directed through a polarizer 110 and then into the process chamber 102. A magnet 112, such as an air core solenoid magnet, surrounds the process chamber 102, and provides for a Faraday rotation 113 of the laser beam. The laser beam exits the process chamber 102 and enters a polarizer 114 and then a detector 116 to provide a detected polarization rotation 118 for lock-in detection 120. The system 100 also includes a function generator 122 coupled to the laser source 106 and to an audio amplifier 124.

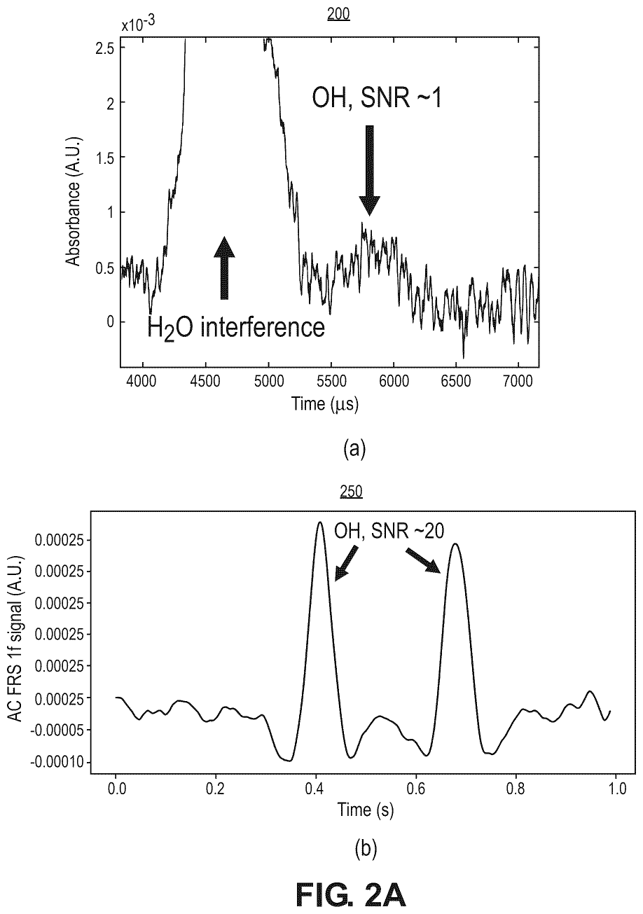

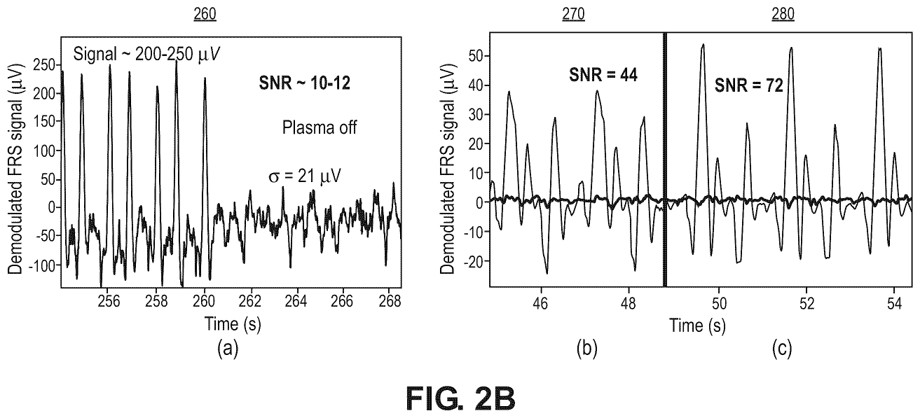

As exemplary spectroscopy data, FIG. 2A illustrates (a) a plot 200 of direct laser absorption, and (b) a plot 250 of Faraday rotation spectroscopy, in accordance with an embodiment of the present disclosure. Referring to plots 200 and 250, OH sensitivity can be enhanced by about 20 times using Faraday rotation spectroscopy and eliminates H₂O interference.

As exemplary modulation data, FIG. 2B illustrates (a) a plot 260 of demodulated Filtered Rayleigh Scattering (FRS) signal (μV) as a function of time (seconds) for magnet modulation with laser scan with plasma off, (B) a plot 270 of demodulated Filtered Rayleigh Scattering (FRS) signal (μV) as a function of time (seconds) for dual modulation (magnet and laser) with plasma off, and (c) a plot 280 of demodulated Filtered Rayleigh Scattering (FRS) signal (μV) as a function of time (seconds) for triple modulation (magnet and laser) with plasma on, in accordance with an embodiment of the present disclosure.

Referring to FIG. 2B, the single modulation approach of plot 260 provides a signal to noise ratio (SNR) of about 10-12. The dual modulation approach of plot 270 provides a signal to noise ratio (SNR) of about 44. The triple modulation approach of plot 280 provides a signal to noise ratio (SNR) of about 71. As such, in an embodiment, triple modulation of the FRS signal provides the highest SNR as compared with dual modulation and single modulation.

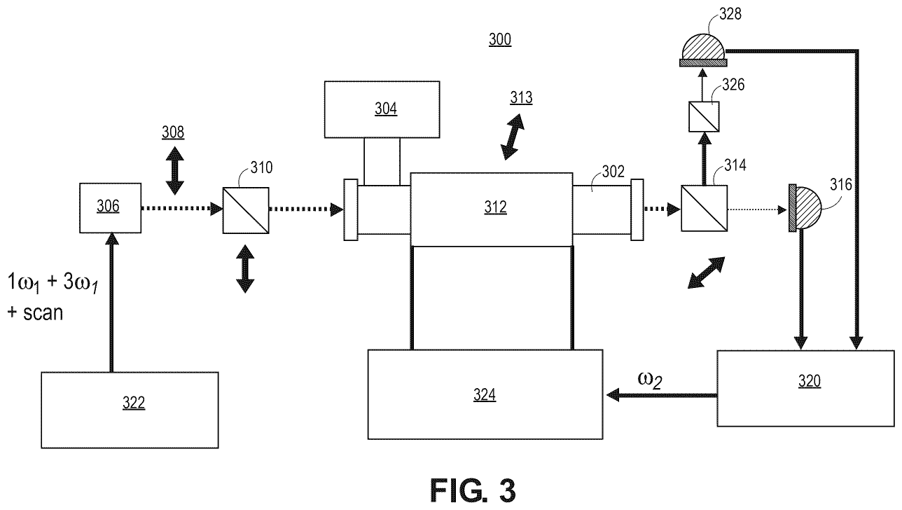

As a second exemplary arrangement, FIG. 3 is a schematic of another system including a magneto-optical sensor for a process chamber, in accordance with an embodiment of the present disclosure.

Referring to FIG. 3, a system 300 includes a process chamber 302 coupled to a remote plasma source 304. A laser 306 provides a laser beam having an initial polarization 308. The laser beam is directed through a polarizer 310 and then into the process chamber 302. A magnet 312, such as an air core solenoid magnet, surrounds the process chamber 302, and provides for a Faraday rotation 313 of the laser beam. The laser beam exits the process chamber 302 and enters a polarizer 314. A first portion of the beam then enters a signal detector 316, and a second portion of the beam enters an attenuating polarizer 326 and then a reference detector 328, to provide differential input to a lock-in amplifier 320, which is coupled to an audio amplifier 324. The system 300 also includes a function generator 322 coupled to the laser source 306.

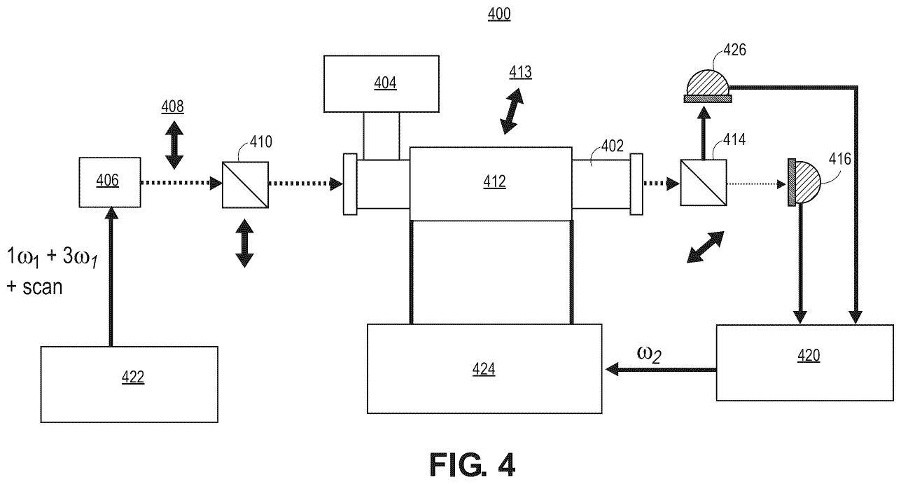

As a third exemplary arrangement, FIG. 4 is a schematic of another system including a magneto-optical sensor for a process chamber, in accordance with an embodiment of the present disclosure.

Referring to FIG. 4, a system 400 includes a process chamber 402 coupled to a remote plasma source 404. A laser 406 provides a laser beam having an initial polarization 408. The laser beam is directed through a polarizer 410 and then into the process chamber 402. A magnet 412, such as an air core solenoid magnet, surrounds the process chamber 402, and provides for a Faraday rotation 413 of the laser beam. The laser beam exits the process chamber 402 and enters a polarizer 414. A first portion of the beam then enters a signal detector 416, and a second portion of the beam enters a reference detector 426, to provide differential input to a lock-in amplifier 420, which is coupled to an audio amplifier 424. The system 400 also includes a function generator 422 coupled to the laser source 406.

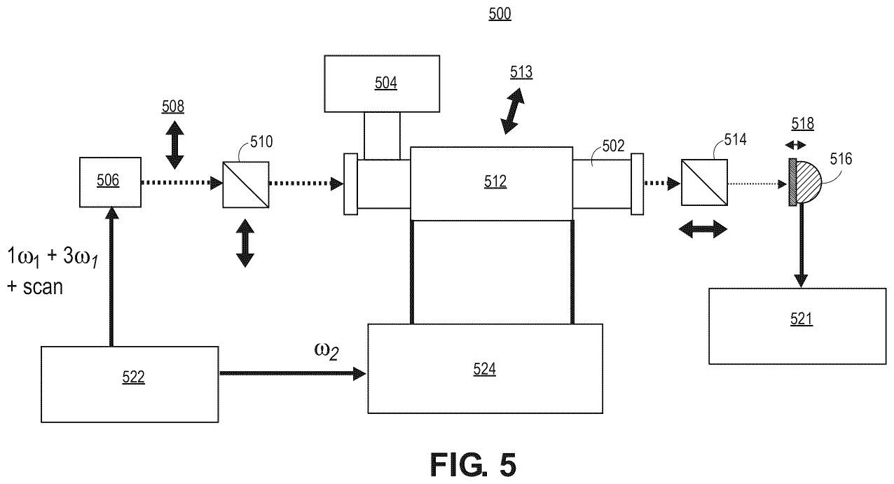

As a fourth exemplary arrangement, FIG. 5 is a schematic of another system including a magneto-optical sensor for a process chamber, in accordance with an embodiment of the present disclosure.

Referring to FIG. 5, a system 500 includes a process chamber 502 coupled to a remote plasma source 504. A laser 506 provides a laser beam having an initial polarization 508. The laser beam is directed through a polarizer 510 and then into the process chamber 502. A magnet 512, such as an air core solenoid magnet, surrounds the process chamber 502, and provides for a Faraday rotation 513 of the laser beam. The laser beam exits the process chamber 502 and enters a polarizer 514 and then a detector 516 to provide a detected polarization rotation 518 to a lock-in amplifier 521. The system 500 also includes a function generator 522 coupled to the laser source 506 and to an audio amplifier 524.

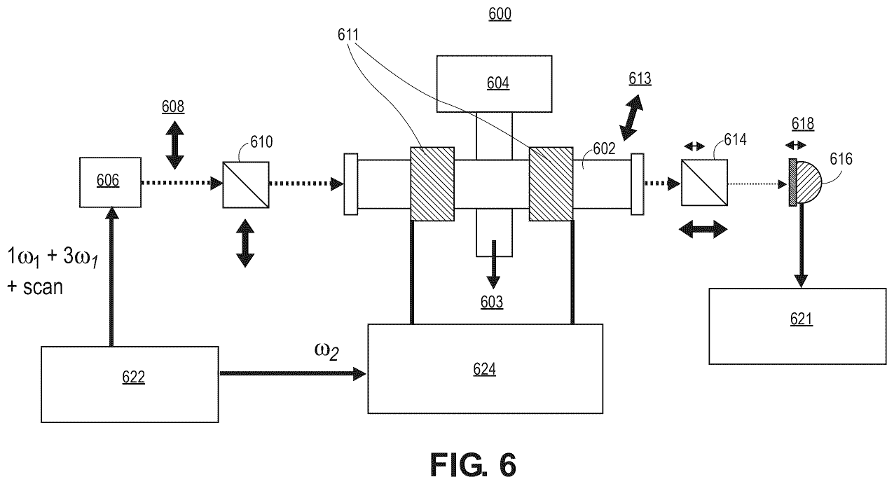

As a fifth exemplary arrangement, FIG. 6 is a schematic of another system including a magneto-optical sensor for a process chamber, in accordance with an embodiment of the present disclosure.

Referring to FIG. 6, a system 600 includes a pre-chamber or factory interface 602 coupled to a process chamber 603 and coupled to a remote plasma source 604. A laser 606 provides a laser beam having an initial polarization 608. The laser beam is directed through a polarizer 610 and then into the pre-chamber or factory interface 602. A Hemholtz coil 611 surrounds the pre-chamber or factory interface 602, and provides for a Faraday rotation 613 of the laser beam. The laser beam exits the pre-chamber or factory interface 602 and enters a polarizer 614 and then a detector 616 to provide a detected polarization rotation 618 to a lock-in amplifier 621. The system 600 also includes a function generator 622 coupled to the laser source 606 and to an audio amplifier 624.

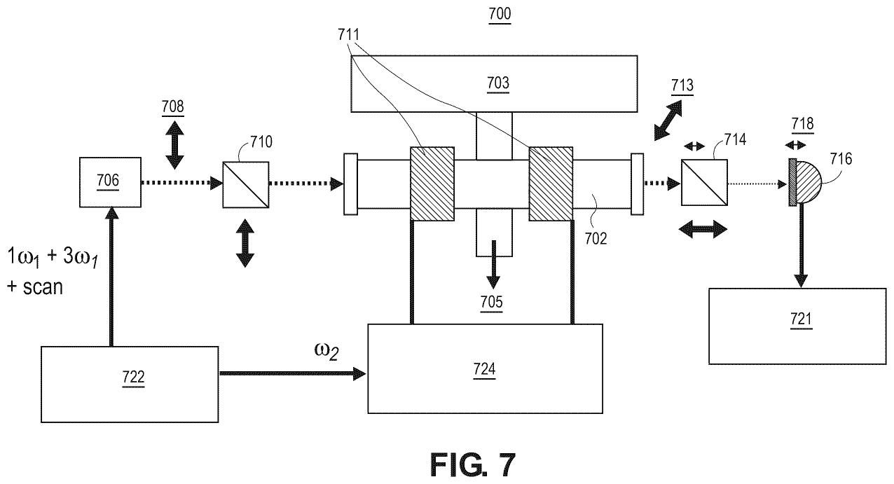

As a sixth exemplary arrangement, FIG. 7 is a schematic of another system including a magneto-optical sensor for a process chamber, in accordance with an embodiment of the present disclosure.

Referring to FIG. 7, a system 700 includes a pre-chamber or factory interface 702 coupled to a process chamber 703 and coupled to a vacuum pump 705. A laser 706 provides a laser beam having an initial polarization 708. The laser beam is directed through a polarizer 710 and then into the pre-chamber or factory interface 702. A Hemholtz coil 711 surrounds the pre-chamber or factory interface 702, and provides for a Faraday rotation 713 of the laser beam. The laser beam exits the pre-chamber or factory interface 702 and enters a polarizer 714 and then a detector 716 to provide a detected polarization rotation 718 to a lock-in amplifier 721. The system 700 also includes a function generator 722 coupled to the laser source 706 and to an audio amplifier 724.

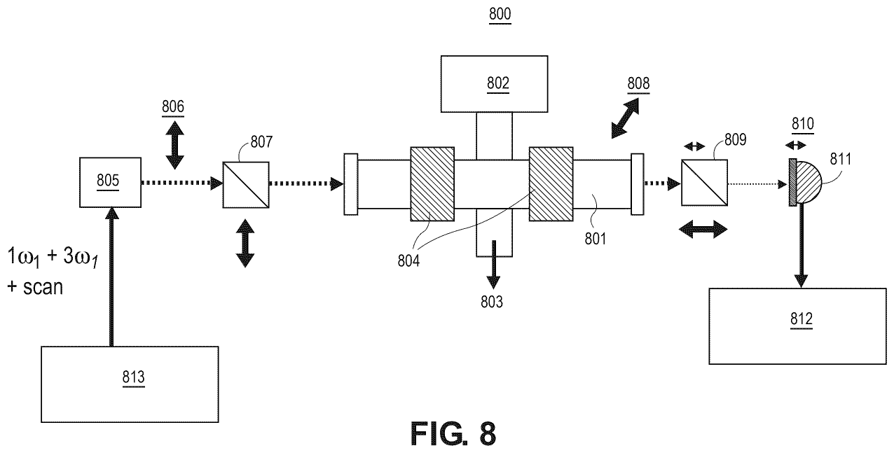

As a seventh exemplary arrangement, FIG. 8 is a schematic of another system including a magneto-optical sensor for a process chamber, in accordance with an embodiment of the present disclosure.

Referring to FIG. 8, a system 800 includes a pre-chamber or factory interface 801 coupled to a process chamber 803 and coupled to a remote plasma source 802. A laser 805 provides a laser beam having an initial polarization 806. The laser beam is directed through a polarizer 807 and then into the pre-chamber or factory interface 801. Permanent magnets 804 surround the pre-chamber or factory interface 801, and provides for a Faraday rotation 808 of the laser beam. The laser beam exits the pre-chamber or factory interface 801 and enters a polarizer 809 and then a detector 811 to provide a detected polarization rotation 810 to a lock-in amplifier 812. The system 800 also includes a function generator 813 coupled to the laser source 805.

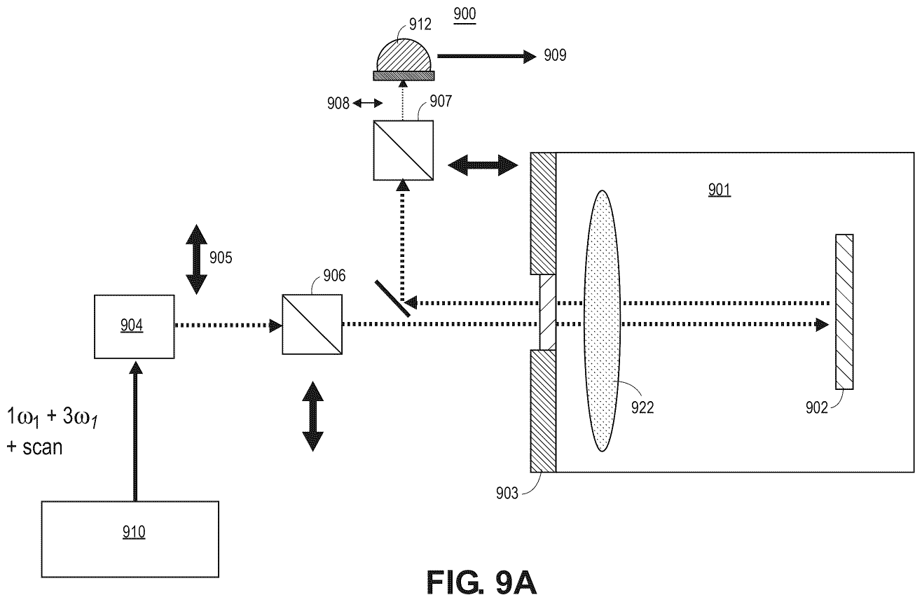

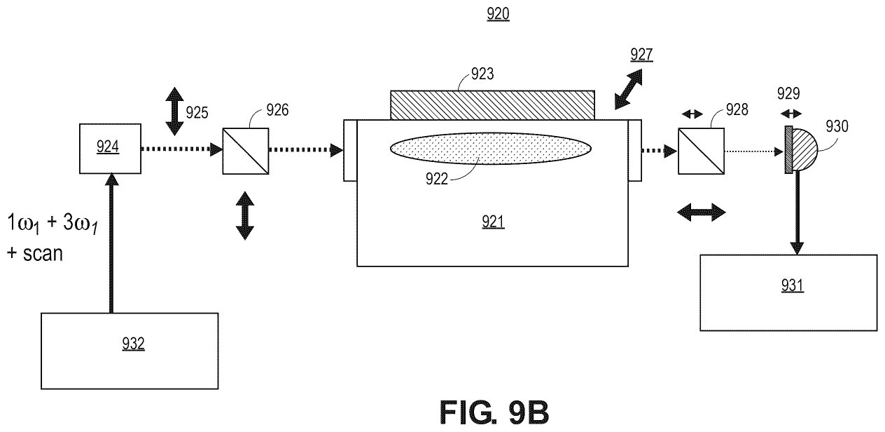

As an eighth exemplary arrangement, FIG. 9A is a schematic of another system including a magneto-optical sensor for a process chamber, in accordance with an embodiment of the present disclosure.

Referring to FIG. 9A, a system 900 includes an inductively coupled plasma (ICP) 901 having a processing region 902 therein, and coupled to an RF coil 903. A laser 904 provides a laser beam having an initial polarization 905. The laser beam is directed through a polarizer 906 and then into the ICP chamber 921. The laser beam is reflected and exits the ICP chamber 901 and enters a polarizer 907 and then a detector 912 to provide a detected polarization rotation 908 to a lock-in amplifier 909. The system 900 also includes a function generator 910 coupled to the laser source 944.

As a ninth exemplary arrangement, FIG. 9B is a schematic of a system including a magneto-optical sensor for a process chamber, in accordance with an embodiment of the present disclosure.

Referring to FIG. 9B, a system 920 includes an inductively coupled plasma (ICP) 921 having a plasma region 922 therein, and coupled to an RF coil 923. A laser 924 provides a laser beam having an initial polarization 925. The laser beam is directed through a polarizer 926 and then into the ICP chamber 921. The laser beam undergoes a Voigt rotation 927. The laser beam exits the ICP chamber 921 and enters a polarizer 928 and then a detector 930 to provide a detected polarization rotation 929 to a lock-in amplifier 931. The system 920 also includes a function generator 932 coupled to the laser source 924.

It is to be appreciated that the above embodiments describe specific arrangements of magneto-optical sensors with respect to corresponding process chambers. Described below are more general examples of locations where a magneto-optical sensor or a portion thereof can be included with respect to a process chamber.

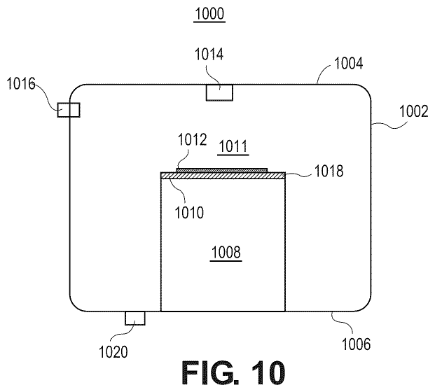

FIG. 10 illustrates a cross-section view of a process chamber including one or more magneto-optical sensors, in accordance with an embodiment of the present disclosure.

Referring to FIG. 10, a process chamber 1000 includes a chamber wall 1002 surrounding a processing region 1011. A wafer or substrate 1012 can be processed in the processing region 1011. A chamber lid 1004 is over the chamber wall 1002, the chamber lid 1004 above the processing region 1011. A chamber floor 1006 is beneath the chamber wall 1002, the chamber floor 1006 below the processing region 1011. A support pedestal 1008 is in the processing region 1011 (and, more particularly, can include a support surface 1010 in the processing region 1011). The support pedestal 1008 is below the chamber lid 1004 and above the chamber floor 1006, and is surrounded by the chamber wall 1004.

Referring again to FIG. 10, in an embodiment, the chamber 1004 wall has an opening there through. A magneto-optical sensor module 1016 is in the opening of the chamber wall 1004. In another embodiment, the chamber lid 1004 includes a magneto-optical module 1014. In another embodiment, the chamber floor 1006 includes an evacuation port. A magneto-optical sensor module 1020 is within or adjacent to the evacuation port. In another embodiment, the support pedestal includes a ring structure (e.g., at location 1018) surrounding a substrate support region. The ring structure includes an opening there through. A magneto-optical sensor module is in the opening of the ring structure. In an embodiment, a process chamber 1000 includes one or more of a magneto-optical sensor module 1016 in the opening of the chamber wall 1004, a magneto-optical sensor module 1014 in the chamber lid 1004, a magneto-optical sensor module within or adjacent to an evacuation port 1020 of the chamber floor 1006, and/or a magneto-optical sensor module is in the opening of the ring structure, e.g., at location 1018. A magneto-optical sensor system can include a sensor module, interface electronics, a controller, and integration with chamber data server for process control and data/process synchronization.

Different locations for a magneto-optical sensor module may be implemented by making modifications to the various components of the sensor housing assembly and/or by modifying how the components interface with the chamber itself. For example, in the case of a chamber wall sensor, a shaft may extend through a port in the chamber wall and the vacuum electrical feedthrough may be external to the chamber. In the case of a lid sensor, a shaft may extend out from the lid into the chamber, and the vacuum electrical feedthrough may be embedded in the lid. In the case of a process ring sensor, a shaft may extend up from a bottom chamber surface and intersect a plasma screen that is adjacent to the process ring. In such embodiments, a vacuum electrical feedthrough may be positioned within a port through the bottom chamber surface. In the case of an evacuation region sensor, the shaft may be inserted through a port through a chamber wall, and the vacuum electrical feedthrough may be outside the chamber wall. In some embodiments, an adapter may be fitted around portions of the magneto-optical sensor housing assembly in order to provide a hermetic seal along ports with any dimension.

In some embodiments, portions of the magneto-optical sensor assembly may be considered a consumable component. For example, the magneto-optical sensor module may be replaced after a certain period of time or after significant sensor drift is detected. The magneto-optical sensor housing assembly may be easily disassembled to allow for simple replacement. In a particular embodiment, a shaft may have a threaded end that screws into a main housing that is attached to the vacuum electrical feedthrough. As such, the shaft and other components attached to the shaft (e.g., the cap and the sensor module) may be removed and replaced by screwing a new shaft to the main housing. In other embodiments, the entire sensor assembly may be considered a consumable component, and the entire sensor assembly may be replaced after a certain period of time or after significant magneto-optical sensor drift is detected.

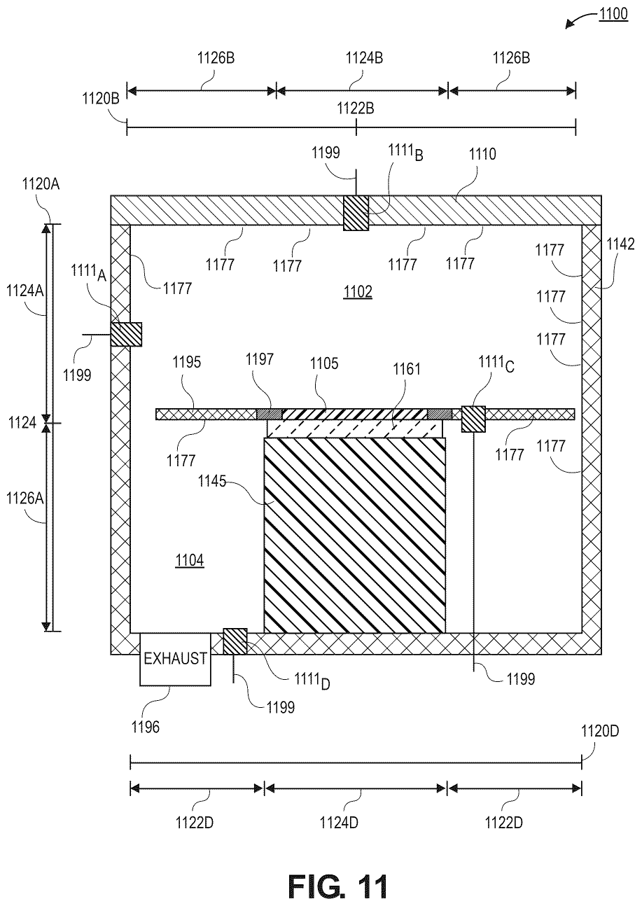

Providing magneto-optical sensor modules, such as those described herein, within a processing apparatus can allow for chamber conditions to be monitored during the execution of various processing recipes, during transitions between substrates, during cleaning operations (e.g., ICC operations), during chamber validation, or during any other desired time. Furthermore, the architecture of the magneto-optical sensor modules disclosed herein allows for integration in many different locations. Such flexibility allows for many different components of a processing apparatus to be monitored simultaneously in order to provide enhanced abilities to determine the cause of chamber drift. For example, FIG. 11 provides a schematic of a deposition apparatus 1100 that includes the integration of magneto-optical sensor modules 1111 in various locations.

As shown, in FIG. 11, the processing apparatus 1100 may include a chamber 1142. A cathode liner 1145 may surround a lower electrode 1161. A substrate 1105 may be secured to the lower electrode 1161. A process ring 1197 may surround the substrate 1105, and a plasma screen 1195 may surround the process ring 1197. In an embodiment, a lid assembly 1110 may seal the chamber 1142. The chamber 1142 may include a processing region 1102 and an evacuation region 1104. The evacuation region 1104 may be proximate to an exhaust port 1196.

In some embodiments, a sidewall sensor module 1111_{A} may be located along a sidewall of the chamber 1142. In some embodiments, the sidewall sensor module 1111_{A} passes through the wall of the chamber 1142 and is exposed to the processing region 1102. In some embodiments, a lid sensor module 1111_{B} is integrated with the lid assembly 1110 and faces the processing region 1102. In some embodiments, a process ring sensor module 1111_{C} is positioned adjacent to the process ring 1197. For example, the process ring sensor module 1111_{C} may be integrated with the plasma screen 1195 that surrounds the process ring 1197. In yet another embodiment, an evacuation region sensor module 1111_{D} may be located in the evacuation region 1104. For example, the evacuation region sensor module 1111_{D} may pass through a bottom surface of the chamber 1142. As shown, each of the sensor modules 1111 includes an electrical lead 1199 that exits the chamber 1142. As such, real time monitoring with the sensor modules 1111 may be implemented.

In an embodiment, sidewall sensor module 1111_{A} is in a location 1120A along a side of chamber 1142. In one embodiment, sidewall sensor module 1111_{A} is in a location 1122A laterally adjacent to a substrate 1105 support region of the lower electrode 1161. In one embodiment, sidewall sensor module 1111_{A} is in a location 1124A vertically between a substrate 1105 support region of the lower electrode 1161 and the lid assembly 1110. In one embodiment, sidewall sensor module 1111_{A} is in a location 1126A vertically between a substrate 1105 support region of the lower electrode 1161 and a floor of the processing apparatus 1100.

In an embodiment, lid sensor module 1111_{B} is in a location 1120B along lid assembly 1110. In one embodiment, lid sensor module 1111_{B} is in a location 1122B coaxial with substrate 1105 support region of the lower electrode 1161. In one embodiment, lid sensor module 1111_{B} is in a location 1124B vertically over substrate 1105 support region of the lower electrode 1161. In one embodiment, lid sensor module 1111_{B} is in a location 1126B vertically over a region outside of substrate 1105 support region of the lower electrode 1161.

In an embodiment, process ring sensor module 1111_{C} is in an inner periphery of plasma screen 1195. In another embodiment, process ring sensor module 1111_{C} is in an outer periphery of plasma screen 1195.

In an embodiment, the evacuation region sensor module 1111_{D} is in a location 1120D along a bottom surface of the chamber 1142. In one embodiment, the evacuation region sensor module 1111_{D} is in a location 1122D vertically beneath a region outside of a substrate support region of the lower electrode 1161. In one embodiment, the evacuation region sensor module 1111_{D} is in a location 1124D vertically beneath a substrate support region of the lower electrode 1161.

Additional exemplary sensor locations are designated as 1177, and are not intended to be limiting in any way.

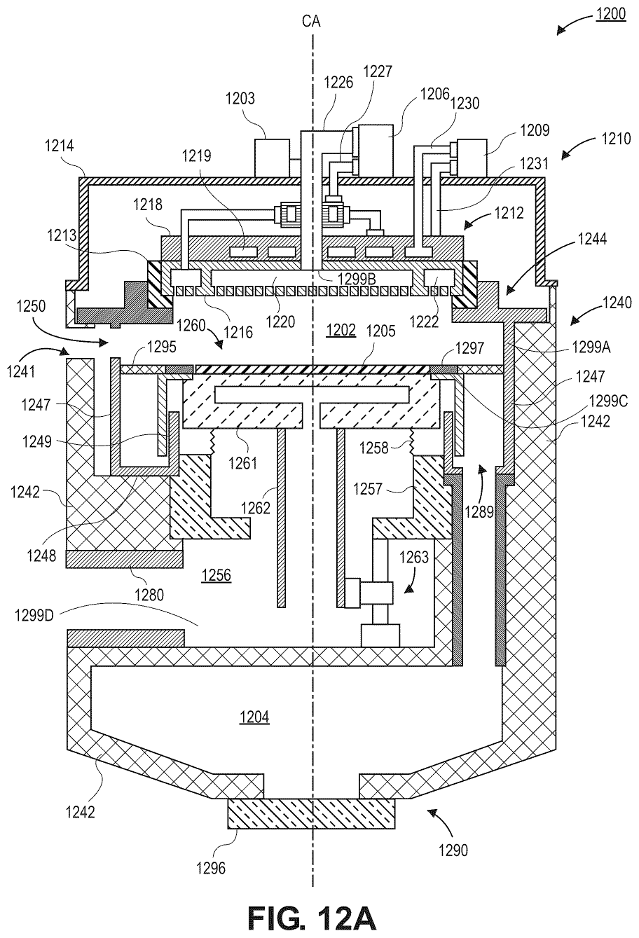

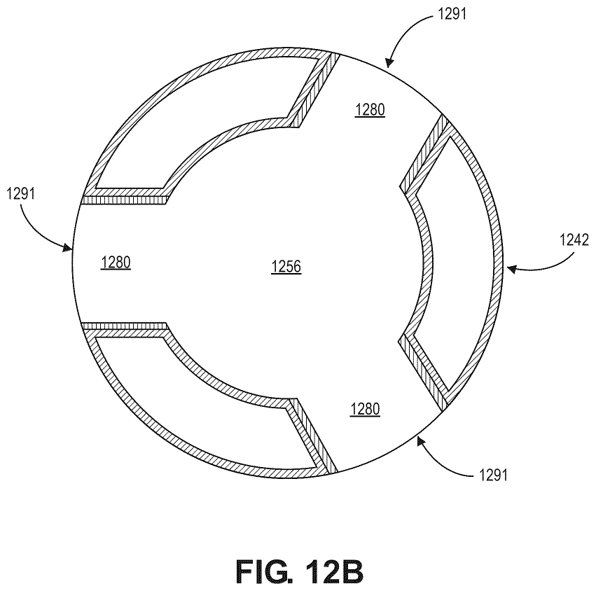

FIG. 12A is a schematic, cross-sectional view of a deposition apparatus 1200 that includes one or more magneto-optical sensor modules, such as those described herein according to an embodiment. The plasma processing apparatus 1200 may be a plasma enhanced chemical vapor deposition chamber, a physical vapor deposition chamber, a plasma treatment chamber, an atomic layer deposition (ALD) chamber, an atomic layer etch (ALE) chamber, or other suitable vacuum processing chamber. As shown in FIG. 12A, the plasma processing apparatus 1200 generally includes a chamber lid assembly 1210, a chamber body assembly 1240, and an exhaust assembly 1290, which collectively enclose a processing region 1202 and an evacuation region 1204. In practice, processing gases are introduced into the processing region 1202 and ignited into a plasma using RF power. A substrate 1205 is positioned on a substrate support assembly 1260 and exposed to the plasma generated in the processing region 1202 to perform a plasma process on the substrate 1205, such as etching, chemical vapor deposition, physical vapor deposition, implantation, plasma annealing, plasma treating, abatement, or other plasma processes. Vacuum is maintained in the processing region 1202 by the exhaust assembly 1290, which removes spent processing gases and byproducts from the plasma process through the evacuation region 1204.

The lid assembly 1210 generally includes an upper electrode 1212 (or anode) isolated from and supported by the chamber body assembly 1240 and a chamber lid 1214 enclosing the upper electrode 1212. The upper electrode 1212 is coupled to an RF power source 1203 via a conductive gas inlet tube 1226. The conductive gas inlet tube 1226 is coaxial with a central axis of the chamber body assembly 1240 so that both RF power and processing gases are symmetrically provided. The upper electrode 1212 includes a showerhead plate 1216 attached to a heat transfer plate 1218. The showerhead plate 1216, the heat transfer plate 1218, and the gas inlet tube 1226 are all fabricated from an RF conductive material, such as aluminum or stainless steel.

The showerhead plate 1216 has a central manifold 1220 and one or more outer manifolds 1222 for distributing processing gasses into the processing region 102. The one or more outer manifolds 1222 circumscribe the central manifold 1220. The central manifold 1220 receives processing gases from a gas source 1206 through the gas inlet tube 1226, and the outer manifold(s) 1222 receives processing gases, which may be the same or a different mixture of gases received in the central manifold 1220, from the gas source 1206 through gas inlet tube(s) 1227. The dual manifold configuration of the showerhead plate 1216 allows improved control of the delivery of gases into the processing region 1202. The multi-manifold showerhead plate 116 enables enhanced center to edge control of processing results as opposed to conventional single manifold versions.

A heat transfer fluid is delivered from a fluid source 1209 to the heat transfer plate 1218 through a fluid inlet tube 1230. The fluid is circulated through one or more fluid channels 1219 disposed in the heat transfer plate 1218 and returned to the fluid source 1209 via a fluid outlet tube 1231. Suitable heat transfer fluids include water, water-based ethylene glycol mixtures, a perfluoropolyether (e.g., Galden® fluid), oil-based thermal transfer fluids, or similar fluids.

The chamber body assembly 1240 includes a chamber body 1242 fabricated from a conductive material resistant to processing environments, such as aluminum or stainless steel. The substrate support assembly 1260 is centrally disposed within the chamber body 1242 and positioned to support the substrate 1205 in the processing region 1202 symmetrically about the central axis (CA). The substrate support assembly 1260 may also support a process ring 1297 that surrounds the substrate 1205. The chamber body 1242 includes a ledge that supports an outer flange of an upper liner assembly 1244. The upper liner assembly 1244 may be constructed from a conductive, process compatible material, such as aluminum, stainless steel, and/or yttria (e.g., yttria coated aluminum). In practice, the upper liner assembly 1244 shields the upper portion of the chamber body 1242 from the plasma in the processing region 1202 and is removable to allow periodic cleaning and maintenance. An inner flange of the upper liner assembly 1244 supports the upper electrode 1212. An insulator 1213 is positioned between the upper liner assembly 1244 and the upper electrode 1212 to provide electrical insulation between the chamber body assembly 1240 and the upper electrode 1212.

The upper liner assembly 1244 includes an outer wall 1247 attached to the inner and outer flanges, a bottom wall 1248, and an inner wall 1249. The outer wall 1247 and inner wall 1249 are substantially vertical, cylindrical walls. The outer wall 1247 is positioned to shield chamber body 1242 from plasma in the processing region 1202, and the inner wall 1249 is positioned to at least partially shield the side of the substrate support assembly 1260 from plasma in the processing region 1202. The bottom wall 1248 joins the inner and outer walls (1249, 1247) except in certain regions where evacuation passages 1289 are formed.

The processing region 1202 is accessed through a slit valve tunnel 1241 disposed in the chamber body 1242 that allows entry and removal of the substrate 1205 into/from the substrate support assembly 1260. The upper liner assembly 1244 has a slot 1250 disposed there through that matches the slit valve tunnel 1241 to allow passage of the substrate 1205 there through. A door assembly (not shown) closes the slit valve tunnel 1241 and the slot 1250 during operation of the plasma processing apparatus.

The substrate support assembly 1260 generally includes lower electrode 1261 (or cathode) and a hollow pedestal 1262, the center of which the central axis (CA) passes through, and is supported by a central support member 1257 disposed in the central region 1256 and supported by the chamber body 1242. The central axis (CA) also passes through the center of the central support member 1257. The lower electrode 1261 is coupled to the RF power source 1203 through a matching network (not shown) and a cable (not shown) routed through the hollow pedestal 1262. When RF power is supplied to the upper electrode 1212 and the lower electrode 1261, an electrical field formed there between ignites the processing gases present in the processing region 1202 into a plasma.

The central support member 1257 is sealed to the chamber body 1242, such as by fasteners and O-rings (not shown), and the lower electrode 1261 is sealed to the central support member 1257, such as by a bellows 1258. Thus, the central region 1256 is sealed from the processing region 1202 and may be maintained at atmospheric pressure, while the processing region 1202 is maintained at vacuum conditions.

An actuation assembly 1263 is positioned within the central region 1256 and attached to the chamber body 1242 and/or the central support member 1257. The actuation assembly 1263 provides vertical movement of the lower electrode 161 relative to the chamber body 142, the central support member 1257, and the upper electrode 1212. Such vertical movement of the lower electrode 1261 within the processing region 1202 provides a variable gap between the lower electrode 1261 and the upper electrode 1212, which allows increased control of the electric field formed there between, in tum, providing greater control of the density in the plasma formed in the processing region 1202. In addition, since the substrate 1205 is supported by the lower electrode 1261, the gap between the substrate 1205 and the showerhead plate 1216 may also be varied, resulting in greater control of the process gas distribution across the substrate 1205.

In one embodiment, the lower electrode 1261 is an electrostatic chuck, and thus includes one or more electrodes (not shown) disposed therein. A voltage source (not shown) biases the one or more electrodes with respect to the substrate 1205 to create an attraction force to hold the substrate 1205 in position during processing. Cabling coupling the one or more electrodes to the voltage source is routed through the hollow pedestal 1262 and out of the chamber body 1242 through one of the plurality of access tubes 1280.

FIG. 12B is a schematic depiction of the layout of the access tubes 1280 within spokes 1291 of the chamber body assembly 1240. The spokes 1291 and access tubes 1280 are symmetrically arranged about the central axis (CA) of the processing apparatus 1200 in a spoke pattern as shown. In the embodiment shown, three identical access tubes 1280 are disposed through the chamber body 1242 into the central region 1256 to facilitate supply of a plurality of tubing and cabling from outside of the chamber body 1242 to the lower electrode 1261. Each of the spokes 1291 are adjacent to an evacuation passage 1289 that fluidically couples the processing region 1202 above the central region 1256 to the evacuation region 1204 below the central region 1256. The symmetrical arrangement of the access tubes 1280 further provides electrical and thermal symmetry in the chamber body 1242, and particularly in the processing region 1202, in order to allow greater more uniform plasma formation in the processing region 1202 and improved control of the plasma density over the surface of the substrate 1205 during processing.

Similarly, the evacuation passages 1289 are positioned in the upper liner assembly 1244 symmetrically about the central axis (CA). The evacuation passages 1289 allow evacuation of gases from the processing region 1202 through the evacuation region 1204 and out of the chamber body 1242 through an exhaust port 1296. The exhaust port 1296 is centered about the central axis (CA) of the chamber body assembly 1240 such that the gases are evenly drawn through the evacuation passages 1289.

Referring again to FIG. 12A, a conductive, mesh liner 1295 is positioned on the upper liner assembly 1244. The mesh liner 1295 may be constructed from a conductive, process compatible material, such as aluminum, stainless steel, and/or yttria (e.g., yttria coated aluminum). The mesh liner 1295 may have a plurality of apertures (not shown) formed there through. The apertures may be positioned symmetrically about a center axis of the mesh liner 1295 to allow exhaust gases to be drawn uniformly there through, which in turn, facilitates uniform plasma formation in the processing region 1202 and allows greater control of the plasma density and gas flow in the processing region 1202. In one embodiment, the central axis of the mesh liner 1295 is aligned with the central axis (CA) of the chamber body assembly 1240.

The mesh liner 1295 may be electrically coupled to the upper liner assembly 1244. When an RF plasma is present within the processing region 1202, the RF current seeking a return path to ground may travel along the surface of the mesh liner 1295 to the outer wall 1247 of the upper liner assembly 1244. Thus, the annularly symmetric configuration of the mesh liner 1295 provides a symmetric RF return to ground and bypasses any geometric asymmetries of the upper liner assembly 1244.

In an embodiment, one or more magneto-optical sensor modules may be located at various locations throughout the processing apparatus 1200. For example, a sensor module (or a portion of the sensor module) may be located in one or more locations, such as, but not limited to, along a sidewall of the chamber 1242, in the evacuation region 1204, adjacent to the process ring 1297 (e.g., integrated into the mesh liner 1295), or integrated with the lid assembly 1210. Accordingly, detection of various deposition conditions in multiple locations through the processing apparatus 1200 may be determined. The chamber conditions supplied by the one or more sensor modules may be used to modify one or more parameters, such as, for example, processing recipe parameters, cleaning schedules for the processing apparatus 1200, component replacement determinations, and the like.

In an embodiment, the processing apparatus 1200 includes a chamber wall magneto-optical sensor module, e.g., at a location 1299A. In an embodiment, the processing apparatus 1200 includes a chamber lid magneto-optical sensor module, e.g., at a location 1299B. In an embodiment, the processing apparatus 1200 includes a chamber floor or evacuation port magneto-optical sensor module within or adjacent to an evacuation port, e.g., at a location 1299D. In an embodiment, the processing apparatus 1200 includes a ring structure magneto-optical sensor module, e.g., at a location 1299C.

In an embodiment, the processing apparatus 1200 includes two or more different magneto-optical sensors selected from the group consisting of a chamber wall magneto-optical sensor module, a chamber lid magneto-optical sensor module, a chamber floor or evacuation port magneto-optical sensor module, a ring structure magneto-optical sensor module. In an embodiment, the processing apparatus 1200 includes two or more same magneto-optical sensors selected from the group consisting of a chamber wall magneto-optical sensor module, a chamber lid magneto-optical sensor module, a chamber floor or evacuation port magneto-optical sensor module, a ring structure magneto-optical sensor module.

In an embodiment, one or more of the chamber wall magneto-optical sensor module, the chamber lid magneto-optical sensor module, the chamber floor or evacuation port magneto-optical sensor module, and/or the ring structure magneto-optical sensor module further includes a thermal sensor. In one embodiment, such a chamber wall magneto-optical sensor module, chamber lid magneto-optical sensor module, or chamber floor or evacuation port magneto-optical sensor module includes a magneto-optical sensor proximate the processing region 1202, and includes the thermal sensor distal from the processing region 1202. In one embodiment, the ring structure magneto-optical sensor module includes a magneto-optical sensor proximate a substrate 1205 support region, and includes the thermal sensor distal from the substrate 1205 support region.

While the processing apparatus 1200 in FIGS. 12A and 12B provides a specific example of a tool that may benefit from the inclusion of sensor modules such as those disclosed herein, it is to be appreciated that embodiments are not limited to the particular construction of FIGS. 12A and 12B. That is, many different plasma chamber constructions, such as, but not limited to those used in the microelectronic fabrication industry, may also benefit from the integration of sensor modules, such as those disclosed herein.

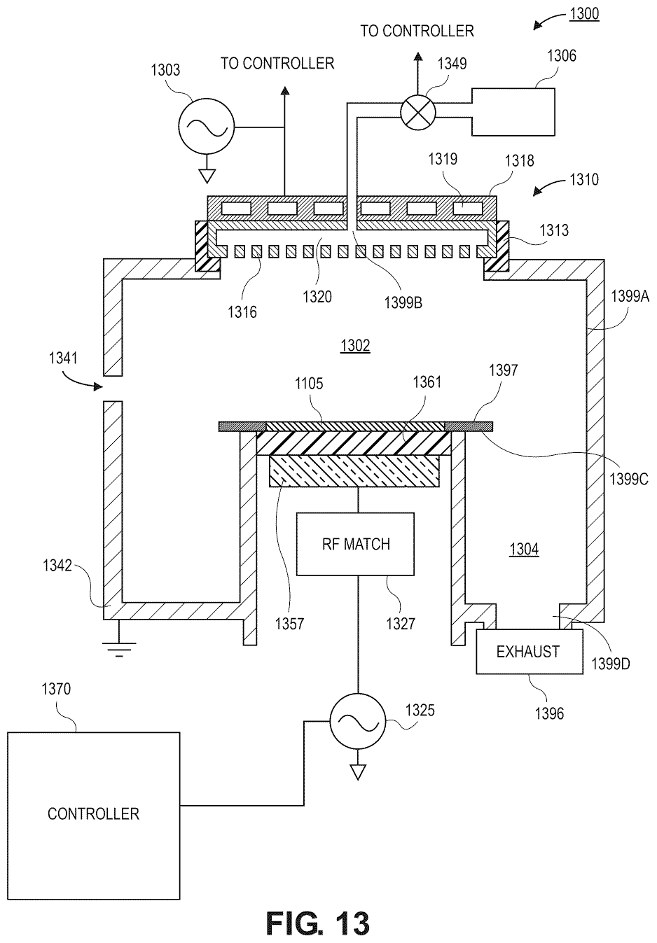

For example, FIG. 13 is a cross-sectional illustration of a deposition apparatus 1300 that can include one or more magneto-optical sensor modules such as those described above, in accordance with an embodiment. The plasma processing apparatus 1300 may be a plasma enhanced chemical vapor deposition chamber, a physical vapor deposition chamber, a plasma treatment chamber, an atomic layer deposition (ALD) chamber, or other suitable vacuum processing chamber.

Processing apparatus 1300 includes a grounded chamber 1342. In some instances, the chamber 1342 may also include a liner (not shown) to protect the interior surfaces of the chamber 1342. The chamber 1342 may include a processing region 1302 and an evacuation region 1304. The chamber 1342 may be sealed with a lid assembly 1310. Process gases are supplied from one or more gas sources 1306 through a mass flow controller 1349 to the lid assembly 1310 and into the chamber 1305. An exhaust port 1396 proximate to the evacuation region 1304 may maintain a desired pressure within the chamber 1342 and remove byproducts from processing in the chamber 1342.

The lid assembly 1310 generally includes an upper electrode including a showerhead plate 1316 and a heat transfer plate 1318. The lid assembly 1310 is isolated from the chamber 1342 by an insulating layer 1313. The upper electrode is coupled to a source RF generator 1303 through a match (not shown). Source RF generator 1303 may have a frequency between 100 and 180 MHz, for example, and in a particular embodiment, is in the 162 MHz band. The gas from the gas source 1306 enters into a manifold 1320 within the showerhead plate 1316 and exits into processing region 1302 of the chamber 1342 through openings into the showerhead plate 1316. In an embodiment, the heat transfer plate 1318 includes channels 1319 through which heat transfer fluid is flown. The showerhead plate 1316 and the heat transfer plate 1318 are fabricated from an RF conductive material, such as aluminum or stainless steel. In certain embodiments, a gas nozzle or other suitable gas distribution assembly is provided for distribution of process gases into the chamber 1342 instead of (or in addition to) the showerhead plate 1316.

The processing region 1302 may include a lower electrode 1361 onto which a substrate 1305 is secured. Portions of a process ring 1397 that surrounds the substrate 1305 may also be supported by the lower electrode 1361. The substrate 1305 may be inserted into (or extracted from) the chamber 1342 through a slit valve tunnel 1341 through the chamber 1342. A door for the slit valve tunnel 1341 is omitted for simplicity. The lower electrode 1361 may be an electrostatic chuck. The lower electrode 1361 may be supported by a support member 1357. In an embodiment, lower electrode 1361 may include a plurality of heating zones, each zone independently controllable to a temperature set point. For example, lower electrode 1361 may include a first thermal zone proximate a center of substrate 1305 and a second thermal zone proximate to a periphery of substrate 1305. Bias power RF generator 1325 is coupled to the lower electrode 1361 through a match 1327. Bias power RF generator 1325 provides bias power, if desired, to energize the plasma. Bias power RF generator 1325 may have a low frequency between about 2 MHz to 60 MHz for example, and in a particular embodiment, is in the 13.56 MHz band.

In an embodiment, the one or more sensor modules may be located at various locations throughout the processing apparatus 1300. For example, a sensor module (or a portion of the sensor module) may be located in one or more locations, such as, but not limited to, at location 1399A along a sidewall of the chamber 1342, at a location 1399D near or in the evacuation region 1304, at a location 1399C adjacent to or within the process ring 1397, and/or integrated with the lid assembly 1310 such as at a location 1399B. Accordingly, detection of various chamber conditions in multiple locations through the processing apparatus 1300 may be determined. The chamber conditions supplied by the one or more sensor modules may be used to modify one or more parameters, such as, for example, processing recipe parameters, cleaning schedules for the processing apparatus 1300, component replacement determinations, and the like.

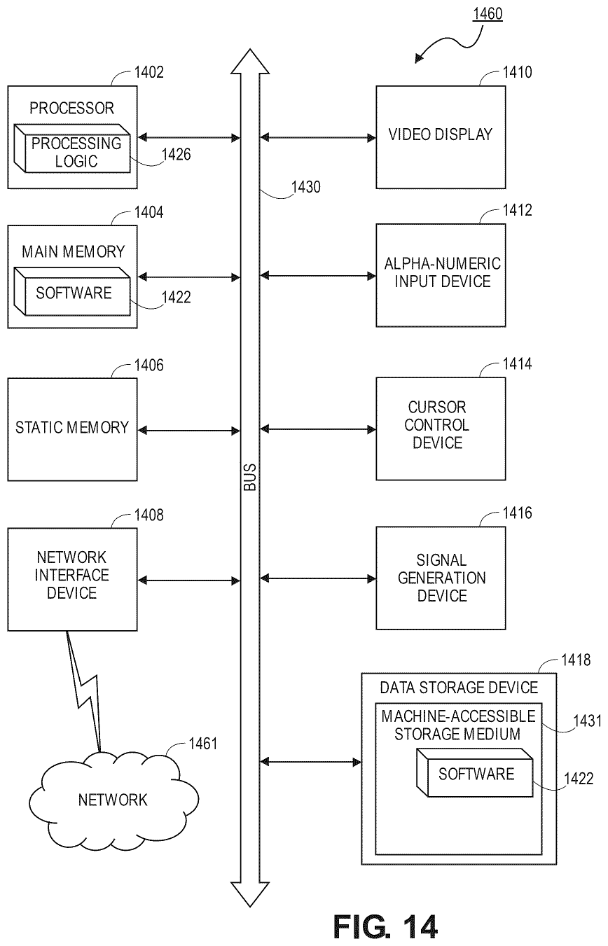

Referring now to FIG. 14, a block diagram of an exemplary computer system 1460 of a processing tool is illustrated in accordance with an embodiment. In an embodiment, computer system 1460 is coupled to and controls processing in the processing tool. The computer system 1460 may be communicatively coupled to one or more magneto-optical sensor modules, such as those disclosed herein. The computer system 1460 may utilize outputs from the one or more magneto-optical sensor modules in order to modify one or more parameters, such as, for example, processing recipe parameters, cleaning schedules for the processing tool, component replacement determinations, and the like.

Computer system 1460 may be connected (e.g., networked) to other machines in a Local Area Network (LAN), an intranet, an extranet, or the Internet. Computer system 1460 may operate in the capacity of a server or a client machine in a client-server network environment, or as a peer machine in a peer-to-peer (or distributed) network environment. Computer system 1460 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 1460, the term “machine” shall also be taken to include any collection of machines (e.g., computers) that individually or jointly execute a set (or multiple sets) of instructions to perform any one or more of the methodologies described herein.

Computer system 1460 may include a computer program product, or software 1422, having a non-transitory machine-readable medium having stored thereon instructions, which may be used to program computer system 1460 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 1460 includes a system processor 1402, a main memory 1404 (e.g., read-only memory (ROM), flash memory, dynamic random access memory (DRAM) such as synchronous DRAM (SDRAM) or Rambus DRAM (RDRAM), etc.), a static memory 1406 (e.g., flash memory, static random access memory (SRAM), etc.), and a secondary memory 1418 (e.g., a data storage device), which communicate with each other via a bus 1430.

System processor 1402 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 1402 may also be one or more special-purpose processing devices such as an application specific integrated circuit (ASIC), a field programmable gate array (FPGA), a digital signal system processor (DSP), network system processor, or the like. System processor 1402 is configured to execute the processing logic 1426 for performing the operations described herein.

The computer system 1460 may further include a system network interface device 1408 for communicating with other devices or machines. The computer system 1460 may also include a video display unit 1410 (e.g., a liquid crystal display (LCD), a light emitting diode display (LED), or a cathode ray tube (CRT)), an alphanumeric input device 1412 (e.g., a keyboard), a cursor control device 1414 (e.g., a mouse), and a signal generation device 1416 (e.g., a speaker).

The secondary memory 1418 may include a machine-accessible storage medium 1431 (or more specifically a computer-readable storage medium) on which is stored one or more sets of instructions (e.g., software 1422) embodying any one or more of the methodologies or functions described herein. The software 1422 may also reside, completely or at least partially, within the main memory 1404 and/or within the system processor 1402 during execution thereof by the computer system 1460, the main memory 1404 and the system processor 1402 also constituting machine-readable storage media. The software 1422 may further be transmitted or received over a network 1461 via the system network interface device 1408. In an embodiment, the network interface device 1408 may operate using RF coupling, optical coupling, acoustic coupling, or inductive coupling.

While the machine-accessible storage medium 1431 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure include magneto-optical sensors for process monitoring and/or process chamber condition monitoring.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. A system comprising:
a process chamber;
a laser source to provide a laser beam having an initial polarization, wherein the laser beam is directed through a first polarizer and then into the process chamber;
a magnet surrounding the process chamber, wherein the magnet provides a Faraday rotation of the laser beam, the laser beam to exit the process chamber and enter a second polarizer; and
a detector to detect a polarization rotation for lock-in detection.

2. The system of claim 1, further comprising:
a function generator coupled to the laser source.

3. The system of claim 2, further comprising:
an audio amplifier coupled to the function generator, the audio amplifier coupled to the magnet.

4. The system of claim 1, wherein the lock-in detection is for OH detection.

5. The system of claim 4, wherein the OH detection is without H₂O interference.

6. A system comprising:
a process chamber;
a laser source to provide a laser beam having an initial polarization, wherein the laser beam is directed through a first polarizer and then into the process chamber;
a magnet surrounding the process chamber, wherein the magnet provides a Faraday rotation of the laser beam, the laser beam to exit the process chamber and enter a second polarizer; and
a detector to detect a polarization rotation, the detector to provide the detected polarization rotation to a lock-in amplifier.

7. The system of claim 6, further comprising:
a function generator coupled to the laser source.

8. The system of claim 6, further comprising:
an audio amplifier coupled to the lock-in amplifier, the audio amplifier coupled to the magnet.

9. The system of claim 6, wherein the second polarizer is coupled to the detector and to and attenuating polarizer, the attenuating polarizer coupled to the lock-in amplifier.

10. The system of claim 6, wherein the second polarizer is coupled to the detector and to and a reference detector, the reference detector coupled to the lock-in amplifier.

11. The system of claim 7, further comprising:
an audio amplifier coupled to the function generator, the audio amplifier coupled to the magnet.

12. The system of claim 6, wherein the detector is for OH detection.

13. The system of claim 12, wherein the OH detection is without H₂O interference.

14. A system including a magneto-optical sensor for a process, the system comprising:
a process chamber;
a laser source to provide a laser beam having an initial polarization, wherein the laser beam is directed through a first polarizer and then into the process chamber;
a Helmholtz coil surrounding the process chamber, wherein the Helmholtz coil provides a Faraday rotation of the laser beam, the laser beam to exit the process chamber and enter a second polarizer;
a detector to detect a polarization rotation, the detector to provide the detected polarization rotation to a lock-in amplifier.

15. The system of claim 14, wherein the process chamber is coupled to a remote plasma source.

16. The system of claim 14, wherein the process chamber is coupled to a vacuum pump.

17. The system of claim 14, further comprising:
a function generator coupled to the laser source.

18. The system of claim 17, further comprising:
an audio amplifier coupled to the function generator, the audio amplifier coupled to the Helmholtz coil.

19. The system of claim 14, wherein the detector is for OH detection.

20. The system of claim 19, wherein the OH detection is without H₂O interference.
